(19) United States
(12) Patent Application Publication
(10) Pub. No.: US 2025/0045121 A1
(43) Pub. Date: Feb. 6, 2025

(54) DETERMINING OPERAND SHAPE BASED ON INTROSPECTION OF REMOTE RESOURCES

(71) Applicant: INTERNATIONAL BUSINESS MACHINES CORPORATION, Armonk, NY (US)

(72) Inventors: Martin A. Ross, Gosport (GB); Robert Convery, Fair Oak (GB); MATTHEW CHRISTOPHER BAILEY, Basingstoke (GB); CAMERON LUKE DENTON ROBERTS, Basingstoke (GB)

(21) Appl. No.: 18/228,797

(22) Filed: Aug. 1, 2023

(51) Int. Cl. G06F 9/50

(52) U.S. Cl. CPC G06F 9/5077; G06F 9/5044

(57) ABSTRACT

A method, system, and computer program product are configured to: receive a custom resource of an operator in a container orchestration system; retrieve a resource file specified in the custom resource; analyze remote resources in the resource file; determine additional resources based on the analyzing the remote resources; and deploy an operand of the custom resource, the operand including the remote resources and the additional resources.

### BACKGROUND

Aspects of the present invention relate generally to container orchestration systems and, more particularly, to determining operand shape based on introspection of remote resources.

Cloud computing infrastructures are becoming increasingly popular due to their increased scalability, agility, and elasticity as well as the ability to quickly provision resources on-demand to meet increased customer requirements. Many cloud computing infrastructures provide services via containerized workloads. A container orchestration system is used for automating the deployment, sizing, and management of workloads in containers. A container orchestration system includes an application programming interface (API) that has a limited set of functions. An operator extends the API to enable more complex applications.

### SUMMARY

In a first aspect of the invention, there is a computer-implemented method including: receiving, by an operator in a container orchestration system, a custom resource of the operator; retrieving, by the operator, a resource file specified in the custom resource; analyzing, by the operator, remote resources in the resource file; determining, by the operator, additional resources based on the analyzing the remote resources; and deploying, by the operator, an operand of the custom resource, the operand including the remote resources and the additional resources.

In another aspect of the invention, there is a computer program product including one or more computer readable storage media having program instructions collectively stored on the one or more computer readable storage media. The program instructions are executable to: receive a custom resource of an operator in a container orchestration system; retrieve a resource file specified in the custom resource; analyze remote resources in the resource file; determine additional resources based on the analyzing the remote resources; and deploy an operand of the custom resource, the operand including the remote resources and the additional resources.

In another aspect of the invention, there is a system including a processor set, one or more computer readable storage media, and program instructions collectively stored on the one or more computer readable storage media. The program instructions are executable to: receive a custom resource of an operator in a container orchestration system; retrieve a resource file specified in the custom resource; analyze remote resources in the resource file; determine additional resources based on the analyzing the remote resources; and deploy an operand of the custom resource, the operand including the remote resources and the additional resources.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a block diagram in accordance with aspects of the present invention.

FIGS. 4A and 4B show portions of exemplary custom resource files in accordance with aspects of the present invention.

FIG. 5 shows a flowchart of an exemplary method in accordance with aspects of the present invention.

FIG. 6 shows a flowchart of an exemplary method in accordance with aspects of the present invention.

### DETAILED DESCRIPTION

Aspects of the present invention relate generally to container orchestration systems and, more particularly, to determining operand shape based on introspection of remote resources. Implementations of the invention dynamically determine an appropriate set of deployment resources in a container-based deployment. In embodiments, an operator retrieves remote resources defining an integration, analyzes the retrieved remote resources to determine associated deployment requirements, and creates a deployment based on the retrieved remote resources and the determined associated deployment requirements. Implementations determine the associated deployment requirements automatically based on the analysis of the retrieved remote resources, thereby eliminating the need for a user to manually specify additional deployment requirements.

Kubernetes is an open-source container orchestration system for automating software deployment, scaling, and management. Aspects of the present disclosure are described using Kubernetes as an example; however, embodiments of the invention are not limited to use with Kubernetes. Instead, embodiments may be used with any suitable container orchestration system that utilizes operators to extend the function of a system API.

Operators are extensions to the Kubernetes API that use custom resources to manage Kubernetes applications and their components. Operators automate software configuration and maintenance activities that are typically performed by human operators. Operators extend the Kubernetes control plane with specialized functionality to manage a workload on behalf of a Kubernetes administrator. An operator includes: a custom resource definition (CRD) that defines a schema of settings available for configuring an operand; a custom resource (CR) which is an instance of the CRD that specifies values for the settings defined by the CRD, in which these values describe the configuration of an operand; and a controller that is customized for the workload and configures the current state of the workload to match the desired state that's represented by the values in the CR. An operand is an installed instance of a custom resource. An operand may be referred to as an integration runtime. Managed resources are the resources (e.g., Kubernetes objects and off-cluster services) that the operator uses to constitute an operand. When a custom resource is created, that triggers the operator, which responds by creating and installing the operand. If the custom resource is deleted, then the operator removes the operand. To install an operand, the operator controller creates the managed resources for that operand and installs them, which causes the cluster to install the operand. A user can specify the configuration of these managed resources in a specification section of the custom resource.

Creating a custom resource comprises creating a file that is provided to the operator. The file may be a YAML (yet another markup language) file, which may be referred to as the CR or the YAML. The CR may be created using an interface (that converts user input into file language) and/or by manually editing the CR itself. The CR includes data that specifies values for the settings defined by the CRD, which include but are not limited to: the operator; the kind of custom resource for this operator (an operator may have plural different custom resources); and a location of remote resources that are used in creating and installing an operand for the custom resource. The location of remote resources specified in the CR may comprise a URL (uniform resource locator), for example, and the URL may store a resource file that contains the remote resources (also called integration logic) that executes in the operand at runtime. The resource file may be a compressed file, such as a zip file. A specific example of a resource file is a BAR file, although implementations are not limited to use with a BAR file.

Depending on the specific integration flow being implemented with a custom resource, the operand may require additional resources beyond those included in the resource file. In current practice, a user manually indicates properties of additional resources when creating the custom resource, e.g., by using one or more selectable fields in an interface for creating the CR or by manually editing the CR to indicate the additional resources. This is problematic because it requires the user creating the custom resource to know what additional resources are needed, and that is not always the case when different team members are performing different tasks for a workload. Requiring this additional manual user input when creating the custom resource makes the entire process more complex and opens the door for errors such as the user not setting the fields at all or by setting the fields incorrectly.

Implementations of the invention address this problem by providing a method, system, and computer program product that are configured to dynamically determine the shape of the operand of a custom resource of an operator, including determining additional resources not included in the resource file, by analyzing the content of the resource file. In this manner, implementations of the invention automatically determine the shape of the operand without requiring manual user input. Embodiments thus represent an improvement over conventional systems because embodiments make the process simpler for the user which improves the user experience and reduces the possibility of mistakes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as operand shape code at block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

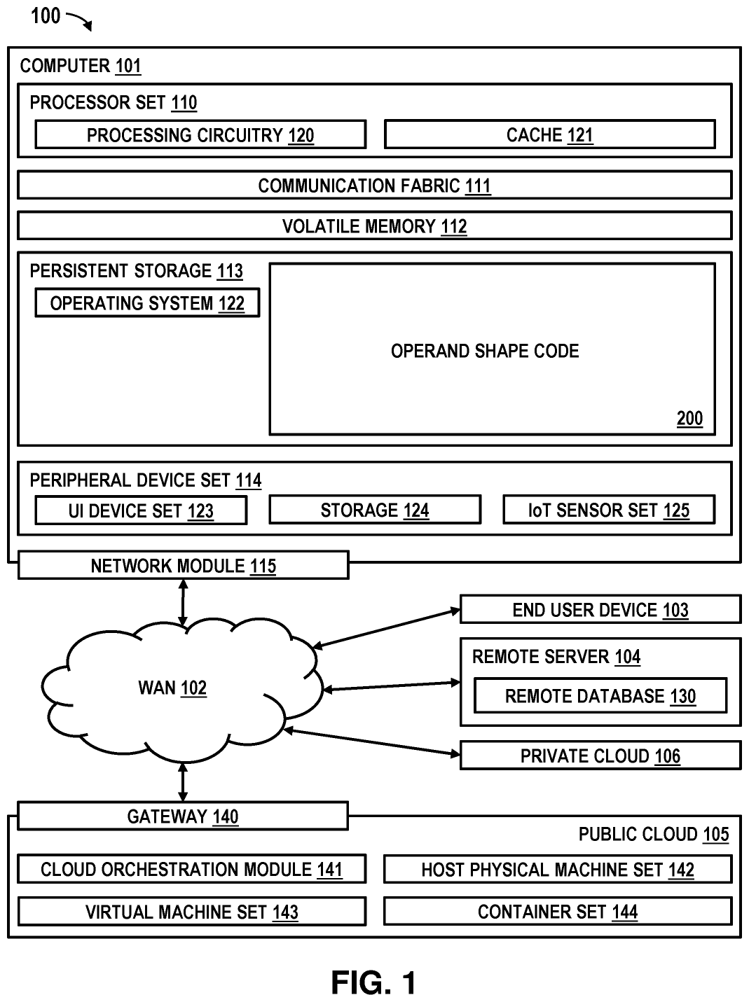

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

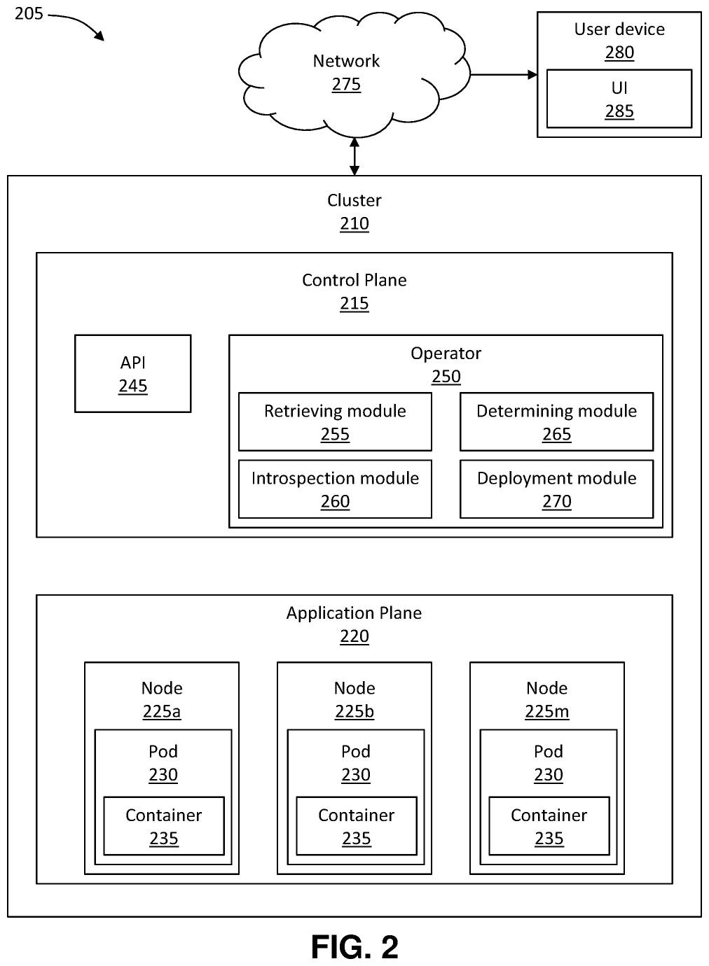

FIG. 2 shows a block diagram of an exemplary environment 205 in accordance with aspects of the invention. In embodiments, the environment 205 includes a cluster 210 that includes a control plane 215 and an application plane 220. In embodiments, the cluster 210 is a computing cluster. For example, the cluster 210 may comprise a Kubernetes cluster. In embodiments, the application plane 220 comprises “m” number of nodes 225a, 225b, . . . , 225m that run one or more applications that provide services to end user devices (not shown). In one example, each node 225a-m comprises a computing device (e.g., a bare-metal server or virtual machine) that hosts one or more pods 230. In this example, each pod 230 contains one or more containers such as Docker containers 235. In an exemplary operation, the pods 230 run on the nodes 225a-m and represent a single instance of a running process in the cluster 210. In embodiments, the control plane 215 manages the nodes 225a-m and the pods 230, e.g., via scheduling, scaling, and other operations.

In accordance with aspects of the invention, the control plane 215 comprises an API 245 and an operator 250, each of which may run on one or more nodes (not shown) similar to the nodes 225a-m. The API 245 lets end users, different parts of the cluster 210, and external components communicate with one another. The API 245 may comprise the Kubernetes API, for example. The operator 250 is a program that runs in the cluster 210 and extends the API 245 with one or more custom resource definitions (CRD), each of which defines a schema of settings available for configuring an operand of a custom resource (CR) associated with the operator 250. The operator 250 may also include a controller (not shown).

In embodiments, the operator 250 comprises a retrieving module 255, introspection module 260, determining module 265, and deployment module 270, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The operator 250 may include additional or fewer modules than those shown in FIG. 2. In embodiments, separate modules may be integrated into a single module. Additionally, or alternatively, a single module may be implemented as multiple modules.

With continued reference to FIG. 2, the environment 205 comprises a network 275 that connects the cluster 210 to a user device 280. The network 275 may comprise the WAN 102 of FIG. 1 and the user device 280 may comprise one or more instances of the EUD 103 of FIG. 1. In embodiments, the user device 280 provides a user interface (UI) 285 in which a user may create a custom resource of the operator 250, e.g., by creating a CR.

In accordance with aspects of the invention, the retrieving module 255 is configured to retrieve remote resources defining an integration. In embodiments, this comprises retrieving a resource file such as a BAR file specified by a URL in the CR.

In accordance with aspects of the invention, the introspection module 260 is configured to analyze the retrieved remote resources. In embodiments, this comprises extracting the remote resources from the resource file and checking the extracted resources to determine whether a flow is indicated and, if so, a type of the flow. This may be done, e.g., by checking for YAML flow artefacts.

In accordance with aspects of the invention, the determining module 265 is configured to determine associated deployment requirements based on the analyzing of the retrieved remote resources. In embodiments, this comprises determining a type of flow found by the introspection module 260 and an additional resource needed to support that type of flow.

In accordance with aspects of the invention, the deployment module 270 is configured to create appropriate deployment resources based on the analysis and determining. In embodiments, this comprises creating an operand including the retrieved remote resources and one or more additional resources determined by the determining module 265.

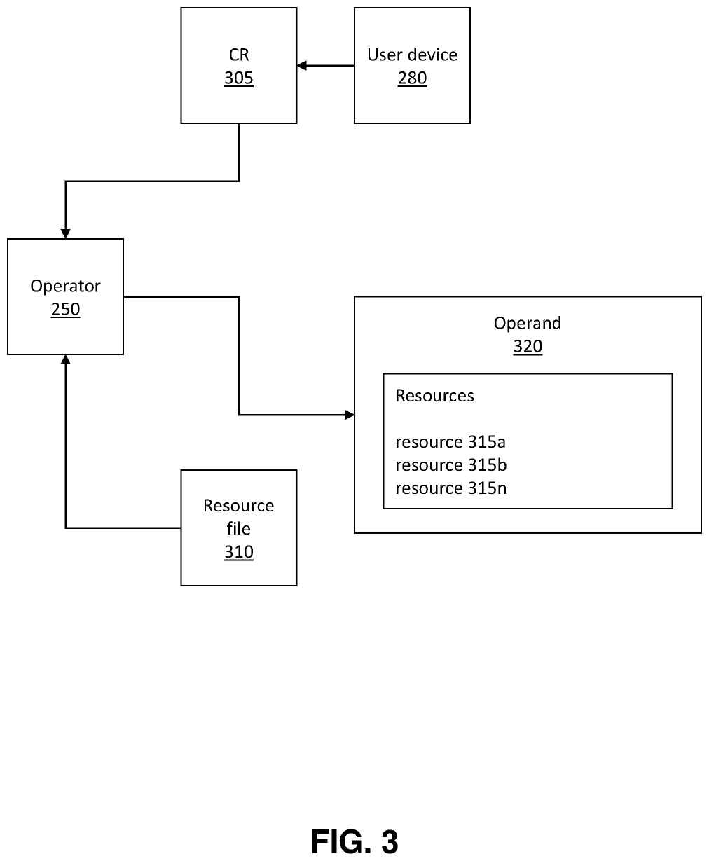

FIG. 3 shows a block diagram in accordance with aspects of the present invention. As shown in the diagram, a user creates a custom resource by creating a CR 305 using the user device 280. The operator 250 receives the CR 305 and retrieves the resource file 310 (e.g., BAR file) from the location specified in the CR 305. In accordance with aspects of the invention, the operator 250 extracts the resources included in the resource file 310 (referred to herein as remote resources) and analyzes these resources to determine additional resources that are needed for the user's integration workflow. In accordance with aspects of the invention, the operator 250 creates and deploys resources 315a-n that define an operand 320, where the resources 315a-n include the resources extracted from the resource file 310 and one or more additional resources determined by analyzing the extracted resources.

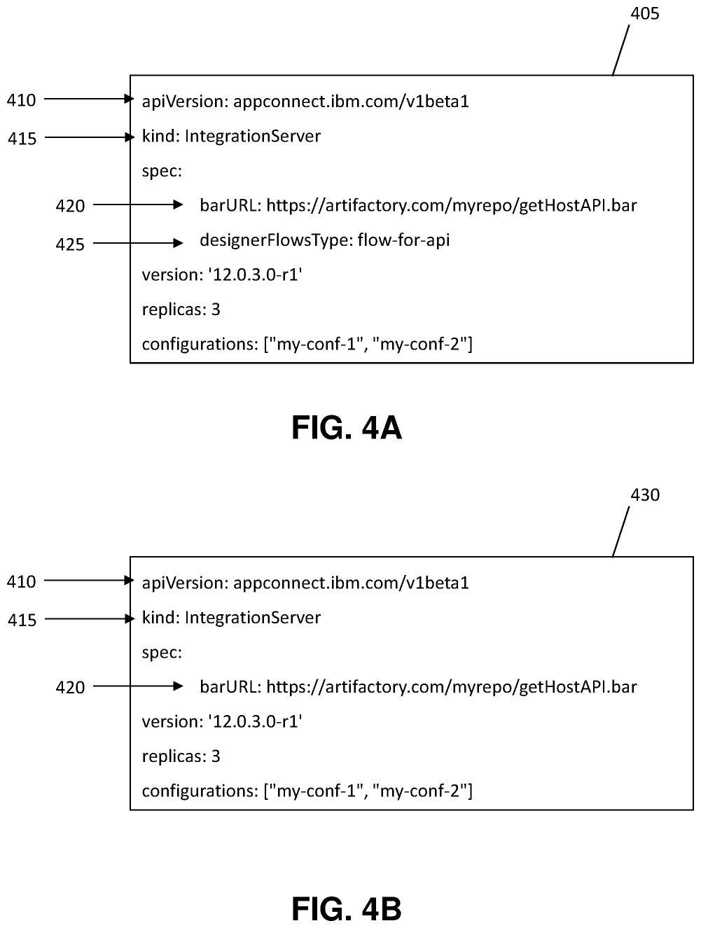

FIG. 4A shows a portion of an exemplary CR 405 for creating a custom resource of an operator. The CR 405 includes data 410 that specifies the operator, data 415 that specifies the kind of custom resource for this operator, data 420 that specifies the location of the resource file, and data 425 that specifies a type of flow. The user must provide input to indicate a type of flow in the data 425. For example, there are several types of integration that could be implemented with the resource file specified by the data 420, including: (i) integration developed in the Toolkit experience; (ii) designer flow-for-api; and (iii) designer event-driven-flow. Type (i) does not require additional containers in the operand beyond the resources included in the resource file; however, types (ii) and (iii) do require additional containers in the operand beyond the resources included in the resource file. As a result of this possibility of different additional resources for different types of flows, the user must provide manual input when creating the CR to specify the type of flow, e.g., as shown at data 425. This adds complexity to the deployment of the user's workload, and this complexity makes the experience less enjoyable for the user and also can lead to mistakes (for example if the user fails to set the field for this data 425 or sets the field incorrectly). Conventional systems require a CR of this format because the shape of the operand is determined by the declaration in the CR, and because conventional operators do not have the ability to dynamically manage additional complexity that needs to be exposed to the user.

FIG. 4B shows a portion of an exemplary CR 430 for creating a custom resource of an operator. The CR 430 includes data 410 that specifies the operator, data 415 that specifies the kind of custom resource for this operator, and data 420 that specifies the location of the resource file. Notably absent from the CR 430 is the data 425 that specifies a type of flow. In accordance with aspects of the invention, the operator 250 of FIG. 2 receives the CR 430, retrieves the resource file specified by the data 420, extracts the resources from the resource file, analyzes the extracted resources to identify flows, determines additional deployment requirements (i.e., additional resources) to support the identified flows, and creates and deploys an operand that includes the extracted resources and the additional deployment requirements.

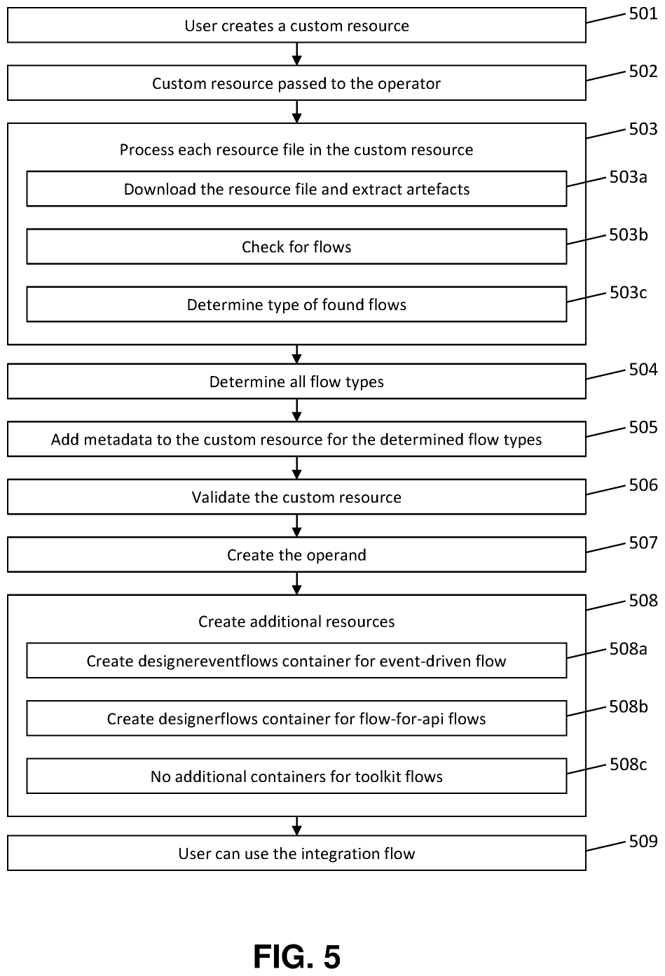

FIG. 5 shows a flowchart of an exemplary method in accordance with aspects of the present invention. Steps of the method may be carried out in the environments of FIGS. 2 and 3 and are described with reference to elements depicted in FIGS. 2 and 3. The method of FIG. 5 corresponds to an exemplary use case having a particular operator, a particular custom resource, and particular types of flows. However, the steps of the method are not limited to use only with this particular use case, and instead the steps can be used with other custom resources for which the operator pulls in resources dynamically from remote locations that could affect the shape of the operand.

At step 501, a user creates a custom resource for an operator. This may comprise the user creating a CR 305 using the user device 280 as shown in FIG. 3. In accordance with aspects of the invention, the user need not specify a flow type when creating the custom resource.

At step 502, the custom resource is passed to the operator. This may comprise the CR 305 being passed to the operator 250 as shown in FIG. 3. In embodiment, the custom resource is passed to the operator in a mutating webhook.

At step 503, the operator processes each resource file listed in the custom resource. This may comprise downloading the resource file from a resource location (e.g., URL) specified in the CR and extracting the artefacts (e.g., remote resources) from the downloaded file (step 503a). In embodiments, step 503 further comprises checking for integration flows (step 503b). This may comprise the operator 250 checking to see if there are any integration flows by checking for any flow artefacts (e.g., documents that indicate flow either explicitly or implicitly). In embodiments, step 503 further comprises determining types of flows (step 503c). For example, if the operator 250 finds flow artefacts in step 503b, then in step 503c the operator 250 examines the flow artefacts to determine a type of flow. Non-limiting examples of types of flows include: synchronous, non-synchronous, REST API, and event driven.

At step 504, the system determines all types of flows found in step 503. For example, the operator 250 summarizes all the types of flows.

At step 505, the system adds metadata to the custom resource for the determined types of flows. In embodiments, the operator 250 adds metadata (e.g., annotations, labels, etc.) to the CR where the metadata specifies the types of flows determined at steps 503 and 504. Example of such metadata include:
appconnect.ibm.com/designerapiflow: ‘false’ (1)
appconnect.ibm.com/designereventflow: ‘false’ (2)
appconnect.ibm.com/toolkitflow: ‘true’ (3)

Expression 1 above is an example of metadata that can be added to a CR to indicate that a flow of type apiflow is not used (as indicated by the value of ‘false’). Expression 2 above is an example of metadata that can be added to a CR to indicate that a flow of type eventflow is not used (as indicated by the value of ‘false’). Expression 3 above is an example of metadata that can be added to a CR to indicate that a flow of type toolkitflow is used (as indicated by the value of ‘true).

At step 506, the system validates the custom resource that now includes the added metadata (from step 505). In embodiments, the operator 250 validates the custom resource to make sure that the types of bars that have been detected align with the type of deployment, e.g., serverless or always-on.

At step 507, the system creates the operand for the custom resource. In embodiments, the operator's reconcile loop triggers to create an operand that backs the custom resource. This can include creating and deploying the resources extracted from the resource file (i.e., the remote resources).

At step 508, the system creates the additional resources. In embodiments, during the reconcile, the operator 250 uses a combination of customer supplied values and/or detected flow types (as recorded in the metadata of step 505) to determine the additional containers to create. At step 508a, if the resource file was determined to contain event-driven flows, then the operator 250 creates the designereventflow container as part of the operand. At step 508b, if the resource file was determined to contain flow-for-api flows, then the operator 250 creates the designerapiflow container as part of the operand. At step 508c, if the resource file was determined to contain toolkit flows, then the operator 250 does not create an additional container for this type of flow. The additional resources created in step 508 are deployed as part of the operand.

At step 509, the user can use the integration flow. In embodiments, the operator 250 completes the reconcile and the user can use the integration flow.

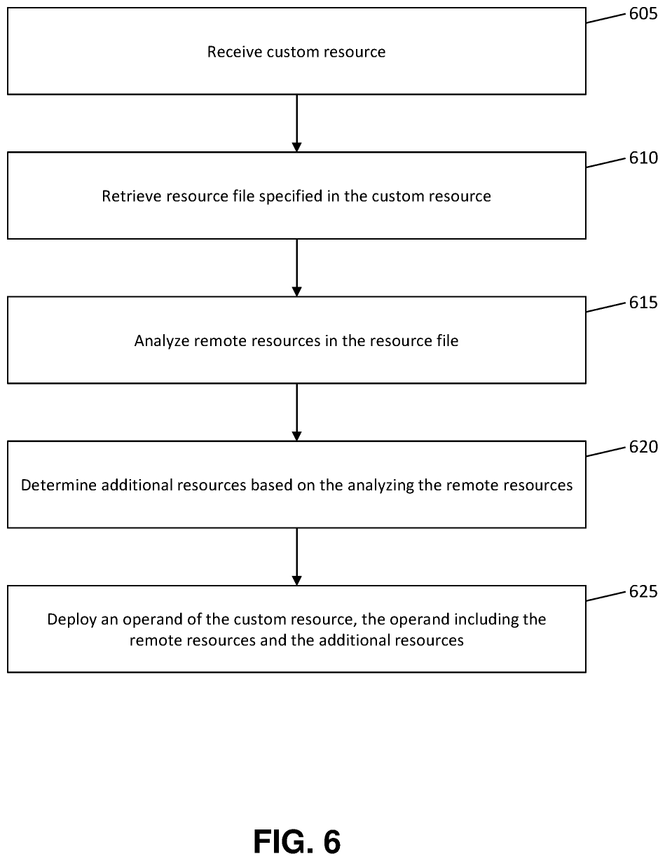

FIG. 6 shows a flowchart of an exemplary method in accordance with aspects of the present invention. Steps of the method may be carried out in the environments of FIGS. 2 and 3 and are described with reference to elements depicted in FIGS. 2 and 3.

At step 605, the system receives a custom resource of an operator in a container orchestration system. In embodiments, the operator 250 receives a custom resource (e.g., CR 305) from a user device 280.

At step 610, the system retrieves a resource file specified in the custom resource. In embodiments, the retrieving module 225 retrieves a resource file (such as a BAR file) from a location (such as a URL) specified in the custom resource.

At step 615, the system analyzes remote resources in the resource file. In embodiments, the introspection module 260 analyzes the remote resources that have been extracted from the resource file. In embodiments, the analysis is configured to determine a type of flow associated with the remote resources.

At step 620, the system determines additional resources based on the analyzing the remote resources. In embodiments, the determining module 265 determines one or more additional resources based on the type of flow determined in the analysis at step 615.

At step 625, the system deploys an operand of the custom resource, the operand including the remote resources and the additional resources. In embodiments, the deployment module 270 creates and deploys the remote resources and the additional resources in one or more pods 230 on one or more nodes 225a-m in the application plane 220. The deploying may comprise creating and deploying particular containers 235 in the one or more pods 230, the containers including the remote resources and the additional resources.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by an operator in a container orchestration system, a custom resource of the operator;
retrieving, by the operator, a resource file specified in the custom resource;
analyzing, by the operator, remote resources in the resource file;
determining, by the operator, additional resources based on the analyzing the remote resources; and
deploying, by the operator, an operand of the custom resource, the operand including the remote resources and the additional resources.

2. The computer-implemented method of claim 1, wherein the operator extends an application programming interface (API) of the container orchestration system with one or more custom resource definitions.

3. The computer-implemented method of claim 2, wherein:
the custom resource specifies a location of the resource file; and
the retrieving the resource file comprises retrieving the resource file from the location.

4. The computer-implemented method of claim 1, further comprising passing the custom resource to the operator in a mutating webhook.

5. The computer-implemented method of claim 1, wherein the analyzing the remote resources comprises determine a type of flow.

6. The computer-implemented method of claim 5, wherein the determining additional resources comprises determining the additional resources based on the type of flow.

7. The computer-implemented method of claim 6, wherein the additional resources comprise one or more containers associated with the type of flow.

8. The computer-implemented method of claim 1, wherein the custom resource comprises a custom resource file and, further comprising adding metadata to the custom resource file based on the analyzing the remote resources.

9. A computer program product comprising one or more computer readable storage media having program instructions collectively stored on the one or more computer readable storage media, the program instructions executable to:
receive a custom resource of an operator in a container orchestration system;
retrieve a resource file specified in the custom resource;
analyze remote resources in the resource file;
determine additional resources based on the analyzing the remote resources; and
deploy an operand of the custom resource, the operand including the remote resources and the additional resources.

10. The computer program product of claim 9, wherein:
the operator extends an application programming interface (API) of the container orchestration system with one or more custom resource definitions;
the custom resource specifies a location of the resource file; and
the retrieving the resource file comprises retrieving the resource file from the location.

11. The computer program product of claim 9, further comprising passing the custom resource to the operator in a mutating webhook.

12. The computer program product of claim 9, wherein:
the analyzing the remote resources comprises determine a type of flow; and
the determining additional resources comprises determining the additional resources based on the type of flow.

13. The computer program product of claim 12, wherein the additional resources comprise one or more containers associated with the type of flow.

14. The computer program product of claim 9, wherein the custom resource comprises a custom resource file and, further comprising adding metadata to the custom resource file based on the analyzing the remote resources.

15. A system comprising:
a processor set, one or more computer readable storage media, and program instructions collectively stored on the one or more computer readable storage media, the program instructions executable to:
receive a custom resource of an operator in a container orchestration system;
retrieve a resource file specified in the custom resource;
analyze remote resources in the resource file;
determine additional resources based on the analyzing the remote resources; and
deploy an operand of the custom resource, the operand including the remote resources and the additional resources.

16. The system of claim 15, wherein:
the operator extends an application programming interface (API) of the container orchestration system with one or more custom resource definitions;
the custom resource specifies a location of the resource file; and
the retrieving the resource file comprises retrieving the resource file from the location.

17. The system of claim 15, further comprising passing the custom resource to the operator in a mutating webhook.

18. The system of claim 15, wherein:
the analyzing the remote resources comprises determine a type of flow; and
the determining additional resources comprises determining the additional resources based on the type of flow.

19. The system of claim 17, wherein the additional resources comprise one or more containers associated with the type of flow.

20. The system of claim 15, wherein the custom resource comprises a custom resource file and, further comprising adding metadata to the custom resource file based on the analyzing the remote resources.
